(19) United States
(12) Patent Application Publication
(10) Pub. No.: US 2026/0213149 A1
(43) Pub. Date: Jul. 23, 2026

(54) QUADRUPOLE MASS FILTERS AND MASS ANALYSERS

(71) Applicant: Micromass UK Limited, Wilmslow (GB)

(72) Inventors: David J. Langridge, Macclesfield (GB); David Gordon, Middlewich (GB)

(73) Assignee: Micromass UK Limited, Wilmslow (GB)

(21) Appl. No.: 19/137,857

(22) PCT Filed: Dec. 12, 2023
(86) PCT No.: PCT/GB2023/053195

§ 371 Date: Jun. 11, 2025

(30) Foreign Application Priority Data
Dec. 13, 2022 (GB) 2218772.8

(51) Int. Cl. H01J 49/42; H01J 49/00; H01J 49/06

(52) U.S. Cl. CPC H01J 49/4215; H01J 49/0031; H01J 49/067; H01J 49/429

(57) ABSTRACT

A method of mass spectrometry comprising: supplying ions having an initial range of axial kinetic energies towards a mass filter; and mass filtering the ions by applying different voltages to electrodes of the mass filter during different respective dwell times so as to provide different mass transmission windows during the different dwell times; wherein the method comprises increasing the range of axial kinetic energies that the ions have, as they pass towards and/or through the mass filter, during at least one of the dwell times.

### CROSS-REFERENCE TO RELATED APPLICATION

This application claims priority from and the benefit of United Kingdom patent application No. 2218772.8 filed on 13 Dec. 2023, the entire contents of which are incorporated herein by reference.

### FIELD OF THE INVENTION

The present invention relates generally to mass spectrometers and in particular to a quadrupole mass filter or mass analyser for use in such a spectrometer.

### BACKGROUND

Resolving quadrupole mass filters and mass analysers are well known devices in which RF and DC voltages are applied to the electrodes of the device so as to select the mass to charge ratios that are capable of being transmitted by it. Typically, in order to achieve optimal mass resolution, the ions entering the mass filter or mass analyser have been collisionally cooled in an upstream device, such as an ion guide, so that the ions have as low an average energy, and spread of energies, as possible.

### SUMMARY

From a first aspect the present invention provides a method of mass spectrometry comprising: supplying ions having an initial range of axial kinetic energies towards a mass filter; and mass filtering the ions by applying different voltages to electrodes of the mass filter during different respective dwell times so as to provide different mass transmission windows during the different dwell times; wherein the method comprises increasing the range of axial kinetic energies that the ions have, as they pass towards and/or through the mass filter, during at least one of the dwell times.

In other words, the method comprises providing the ions that pass through the mass filter, during a given one of the dwell times, with a range of axial kinetic energies that is larger than said initial range of axial kinetic energies.

The step of increasing the range of axial kinetic energies causes ions of a given mass to charge ratio to exit the mass filter, over the duration of that dwell time, over a relatively wide range of radial displacements from a central axis of the mass filter. This helps ensure that the proportion of ions that exit the mass filter and are transmitted downstream through the mass spectrometer is relatively insensitive to small shifts in the nominal mass transmission window of the mass filter at that dwell time.

For the avoidance of doubt, the axial kinetic energy is the kinetic energy of the ions in the downstream direction from an ion source to the mass filter, e.g. along the central axis of the mass filter.

It will be appreciated that the step of increasing the range of axial kinetic energies of the ions as they pass towards the mass filter causes these ions to enter the mass filter with the increased range of axial kinetic energies.

The mass filter may be a DC resolving quadrupole rod set mass filter.

Said step of applying different voltages to the mass filter during different respective dwell times may comprise applying different combinations of RF voltage amplitude and DC voltage amplitude to the mass filter at different respective dwell times.

The RF voltage amplitude and the DC voltage amplitude may be maintained constant during any given dwell time.

The ions may enter the mass filter substantially at its central, longitudinal axis. The voltages applied to the mass filter during any given dwell time cause ions within the mass transmission window for that dwell time to be radially confined towards the central axis. Ions of any given mass to charge ratio, within the mass transmission window, radially oscillate about the central axis with substantially the same (temporal) frequency. As the range of axial kinetic energies of the ions is increased, during said at least one of the dwell times, the ions of the same mass to charge ratio will exit the mass filter over a wider range of radial displacements from the central axis than they would have done if their energies had not been increased (for each of said at least one of the dwell times).

Accordingly, for each of said at least one of the dwell times, said step of increasing the range of axial kinetic energies may cause ions of a given mass to charge ratio to exit the mass filter over the duration of that dwell time with a wider range of radial displacements from a central axis of the mass filter than the ions would have done if their axial kinetic energy had not been increased.

The method may comprise providing a physical aperture, or an ion-optical device having an ion acceptance aperture defined by electric fields of the ion-optical device, downstream of the mass filter for receiving ions transmitted by the mass filter.

The physical aperture may be an aperture in an electrode, or an aperture in a wall of the spectrometer, such as a differential pumping aperture between two chambers of the spectrometer (e.g. two vacuum chambers). The ion acceptance aperture may be the entrance aperture to an ion-optical device such as an ion lens, ion guide or mass filter etc.

The method may comprise detecting the ions transmitted during said different dwell times, or fragment or product ions thereof, downstream of the mass filter so as to generate mass spectral data, and summing the mass spectral data obtained over said different dwell times; optionally so as to form at least one mass peak corresponding to ions transmitted by the mass filter during said different dwell times, or for the fragment or product ions thereof.

Said fragment or product ions may be generated by fragmenting or reacting the ions transmitted by the mass filter.

It will be appreciated that the mass filter may be coupled to an ion detector so as to form a mass analyser.

Said step of increasing the range of axial kinetic energies may comprise performing a plurality of cycles during each of said at least one of the dwell times, wherein each cycle comprises modulating the axial kinetic energy of the ions passing towards and/or through the mass filter between a minimum axial kinetic energy and a maximum axial kinetic energy.

During each cycle, the axial kinetic energy may be varied in a continuous and progressive manner between the maximum and minimum values (e.g. in a linear manner), or it may be discontinuously stepped between a plurality of values.

The method may comprise performing at least 5 cycles during each of said at least one of the dwell times. Optionally, at least 10 cycles may be performed during each of said at least one of the dwell times.

It is also contemplated that only a single cycle may be performed for each of said one or more dwell times. Alternatively, only a portion of one of said cycles may be performed during each of said at least one of the dwell times, e.g. for short dwell times where there may not be time for a full cycle of modulating the axial kinetic energy.

For example, the method may comprise performing a plurality of mass scan cycles, wherein in each mass scan cycle the mass transmission window of the mass filter is scanned over a mass range; and the cycles of modulating the axial kinetic energy of the ions may be performed asynchronously with the mass scan cycles. The ion signal for the multiple mass scan cycles may be summed so as to form a mass peak.

Said step of increasing the range of axial kinetic energies that the ions have may comprise: providing the ions that reach the exit of the mass filter, over the course of one of the dwell times, with a first range of axial kinetic energies that are distributed about a first average axial kinetic energy; and providing the ions that reach the exit of the mass filter, over the course of another of the dwell times, with a second range of axial kinetic energies that are distributed about a second average axial kinetic energy; wherein the second range of axial kinetic energies is wider than the first range of axial kinetic energies, and the second average axial kinetic energy is higher than the first average axial kinetic energy.

This ensures that the ions that reach the exit of the mass filter over the course of a given dwell time have a relatively wide range of axial kinetic energies relative to their average kinetic energy. These ions therefore exit the mass filter, over the course of a given dwell time, over a relatively large range of radial displacements from the central axis of the mass filter.

Said step of increasing the range of axial kinetic energies may comprise providing a DC potential difference along an axial region of the mass filter, or along an axial region upstream of the mass filter, and varying the DC potential difference during each of said at least one of the dwell times such that ions entering said axial region at different times are imparted with different axial kinetic energies.

For example, an ion-optical device such as an ion guide may be provided upstream of the mass filter and DC voltages may be applied to these devices such that a potential difference is provided between the ion-optical device and mass filter. Either one, or both, of these DC voltages may be varied during each of said one or more dwell times such that ions entering said axial region at different times are imparted with different axial kinetic energies.

The DC potential difference may be cycled between maximum and minimum values one or more times during each of said one or more dwell times. Alternatively, as described above, only a portion of one of the cycles may be performed during each of said at least one of the dwell times. For instance, if a plurality of mass scan cycles are performed, the cycles of modulating the DC potential difference may be performed asynchronously with the mass scan cycles. The ion signal for the multiple mass scan cycles may be summed so as to form a mass peak.

The inventors have recognised that the spread of the axial kinetic energies of the ions can be increased for mass transmission windows that transmit ions having relatively low mass to charge ratios, without this being detrimental to the mass resolution of the mass filter. This is because although such devices are typically operated so that they have a high mass resolution for mass transmission windows that transmit ions of relatively high mass to charge ratio, they tend to have a lower mass resolution for mass transmission windows that transmit ions of relatively lower mass to charge ratios. This is particularly the case when all of the mass transmission windows have the same width, i.e. the same range of mass to charge ratios, because mass resolution is defined by the mass to charge ratio transmitted divided by the width of the mass transmission window.

Accordingly, the method may comprise increasing the range of axial kinetic energies of the ions, as they pass towards and/or through the mass filter, so that the ions have a first range of axial kinetic energies during a first of said dwell times, during which the mass filter has a mass transmission window set to transmit ions in a first range of mass to charge ratios; wherein the method further comprises: (i) increasing the range of axial kinetic energies of the ions, as they pass towards and/or through the mass filter, so that the ions have a second range of axial kinetic energies that is narrower than said first range of axial kinetic energies during a second of said dwell times, during which the mass filter has a mass transmission window set to transmit ions in a second range of mass to charge ratios that is higher than said first range of mass to charge ratios; and/or (ii) not increasing the range of axial kinetic energies of the ions, as they pass towards and/or through the mass filter, during a dwell time at which the mass filter has a mass transmission window set to transmit ions in a range of mass to charge ratios that is higher than the first and/or second range of mass to charge ratios.

The method described herein may be performed within a single experimental run.

For example, ions may be substantially continually supplied to the mass filter whilst the mass filter is scanned so as to have the different mass transmission windows at the different dwell times.

All of the dwell times may be the same duration.

All of the mass transmission windows may have the same width, i.e. the same range of mass to charge ratios. For example, the mass transmission windows may each have a width of ≤1 Da, ≤0.8 Da, ≤0.6 Da, ≤0.4 Da, or ≤0.2 Da.

In order to obtain a relatively high mass resolution it is desirable to provide the ions with a relatively long transit time through the mass filter, so that the ions are subjected to the electric fields therein for longer. The inventors have recognised that as the mass resolution of a mass filter tends to be relatively low for ions of low mass to charge ratios, the average energy of these ions can be increased (i.e. the transit time through the mass filter can be decreased) without negatively impacting on the mass resolution that is achieved by the mass filter. In contrast, as the mass resolution of a mass filter is relatively high for higher mass to charge ratios, it is desirable for the average kinetic energy of these ions to be minimised so as to maintain the higher mass resolution that is able to be achieved by the mass filter.

Accordingly, the method may comprise providing the ions with a first average axial kinetic energy through the mass filter during a dwell time at which the mass filter has a mass transmission window set to transmit ions in one range of mass to charge ratios; and providing the ions with a second average axial kinetic energy through the mass filter, that is lower than the first average axial kinetic energy, during a dwell time at which the mass filter has a mass transmission window set to transmit ions in a range of mass to charge ratios that is higher than said one range of mass to charge ratios.

The method may comprise collisionally cooling the ions prior to providing the ions to the mass filter. The ions may therefore be collisionally cooled before performing said step of increasing the range of axial kinetic energies of the ions.

The first aspect of the present invention also provides a mass spectrometer comprising: a mass filter having electrodes; at least one voltage supply for applying voltages to the electrodes; and control circuitry configured to control the mass spectrometer to: supply ions having an initial range of axial kinetic energies towards the mass filter; control the at least one voltage supply to apply different voltages to electrodes of the mass filter during different respective dwell times so as to provide the mass filter with different mass transmission windows during the different dwell times; and increase the range of axial kinetic energies that the ions have, as they pass towards and/or through the mass filter, during at least one of the dwell times.

The spectrometer may have any of the features, or be configured to perform any of the methods, described above in relation to the method according to the first aspect of the invention.

For example, the mass filter may be a DC resolving quadrupole rod set mass filter. The mass spectrometer may comprise a physical aperture, or an ion-optical device having an ion acceptance aperture defined by electric fields of the ion-optical device, downstream of the mass filter for receiving ions transmitted by the mass filter.

The physical aperture may be an aperture in an electrode, or an aperture in a wall of the spectrometer, such as a differential pumping aperture between two chambers of the spectrometer (e.g. two vacuum chambers). The ion acceptance aperture may be the entrance aperture to an ion-optical device such as an ion lens, ion guide or mass filter etc.

The spectrometer has an ion detector and may be configured to: detect the ions transmitted during said different dwell times, or fragment or product ions thereof; to generate mass spectral data; and to sum the mass spectral data obtained over said different dwell times.

The mass filter may be coupled to an ion detector so as to form a mass analyser.

The spectrometer may have a fragmentation or reaction device downstream of the mass filter for fragmenting or reacting ions transmitted by the mass filter so as to form said fragment or product ions.

The mass spectrometer comprises electrodes and one or more voltage supplies that may be configured to provide a DC potential difference along an axial region of the mass filter, or along an axial region upstream of the mass filter, wherein the control circuitry is configured to control the mass spectrometer to increase the range of axial kinetic energies by controlling the one or more voltage supplies so as to vary the DC potential difference during each of said at least one of the dwell times such that ions entering said axial region at different times are imparted with different axial kinetic energies.

For example, an ion-optical device such as an ion guide may be provided upstream of the mass filter and DC voltages may be applied to these devices such that a potential difference is provided between the ion-optical device and mass filter. Either one, or both, of these DC voltages may be varied during each of said one or more dwell times such that ions entering said axial region at different times are imparted with different axial kinetic energies.

The DC potential difference may be cycled between maximum and minimum values one or more times (or only a partial cycle) during each of said one or more dwell times.

Although the mass filter has been described as being operated so as to apply different voltages to electrodes of the mass filter during different dwell times so as to provide different respective mass transmission windows during the different dwell times, it is also contemplated that the invention need not be limited to this. For example, even if the mass filter is not scanned between different mass transmission windows, the step of increasing the range of axial kinetic energies of the ions as they pass towards and/or through the mass filter will result in the ions exiting the mass filter with a relatively broad range of radial displacements from the central axis and therefore ensure a minimum transmission level of ions through a downstream aperture or ion acceptance aperture. For instance, the techniques described herein may be used whilst the mass filter is parked at a particular MRM transition.

Accordingly, from a second aspect the present invention also provides a method of mass spectrometry comprising: supplying ions towards a mass filter having a mass transmission window; and increasing the range of axial kinetic energies that the ions have as they pass towards and/or through the mass filter.

The method according to the second aspect may have any of the features described in relation to the method of the first aspect, except that it need not necessarily be limited to the mass filter having different mass transmission windows during different dwell times.

The second aspect the present invention also provides a mass spectrometer comprising: a mass filter having electrodes; at least one voltage supply for applying voltages to the electrodes so as to provide the mass filter with a mass transmission window; and control circuitry configured to control the mass spectrometer to: supply ions towards the mass filter; and increase the range of axial kinetic energies that the ions have as they pass towards and/or through the mass filter.

The mass spectrometer according to the second aspect may have any of the features described in relation to the first aspect, except that it need not necessarily be limited to the mass filter having different mass transmission windows during different dwell times.

It has been recognised that alternative techniques may be used to mitigate the problems discussed herein. As such, the range of axial kinetic energies that the ions have, as they pass towards and/or through the mass filter, need not necessarily be increased and other techniques may be used instead.

Accordingly, from a third aspect the present invention provides a method of mass spectrometry comprising: (i) mass filtering ions using a mass filter having a mass transmission window; (ii) repeatedly scanning the mass transmission window across a range of mass to charge ratios that has a width of less than 1 Da.

The third aspect of the present invention may have any of the features described in relation to the first and second aspects of the present invention, except that the range of axial kinetic energies that the ions have, as they pass towards and/or through the mass filter, need not necessarily be increased.

For the avoidance of doubt, according to the third aspect, the mass transmission window has a width that is smaller than said range of mass to charge ratios. For example, the mass transmission window may have a width that is ≤0.8 Da, ≤0.7 Da or ≤0.6 Da.

The step of repeatedly scanning may be performed during a single experimental run, such as over a period during which ions are substantially continually supplied to the mass filter and/or during which analyte is continually supplied to a mass spectrometer that comprises the mass filter.

The step of repeatedly scanning may be performed over a time period and ions transmitted by the mass filter during said time period, or ions derived therefrom, are detected so as to obtain mass spectral data; and the mass spectral data may be summed or averaged.

The method may comprise associating the summed or averaged mass spectral data with a mass to charge ratio within said range of mass to charge ratios.

For example, the mass spectral data may be associated with a mass to charge ratio in the centre of the range of mass to charge ratios that the mass transmission window is repeatedly scanned across.

It will be appreciated that the mass transmission window is set by selecting the voltages that are applied to electrodes of the mass filter, i.e. RF and/or DC voltages. The step of repeatedly scanning may be performed by varying the amplitudes of RF and/or DC voltages applied to electrodes of the mass filter.

The step of repeatedly scanning may comprise scanning the mass transmission window back and forth in opposing directions across said range of mass to charge ratios.

Alternatively, and less preferably, the step of repeatedly scanning may repeatedly scan the mass transmission window in the same direction across said range of mass to charge ratios, e.g. in the direction of either increasing or decreasing mass to charge ratio.

The method may comprise selecting a target mass to charge ratio that is desired to be transmitted by the mass filter and then performing said steps of mass filtering and repeatedly scanning, wherein said range of mass to charge ratios that the mass transmission window is repeatedly scanned across includes said target mass to charge ratio.

For example, the method may form part of a multiple reaction monitoring experiment for analysing a target ion of interest having said target mass to charge ratio, and said steps of mass filtering and repeatedly scanning may be performed in order to cause the mass filter to transmit the target ion of interest.

Alternatively, step (ii) may be repeated a plurality of times, wherein the range of mass to charge ratios that the mass transmission window is repeatedly scanned across is varied each time that step (ii) is performed. Step (ii) may be repeated said plurality of times during a single experimental run, such as over a period during which ions are substantially continually supplied to the mass filter and/or during which analyte is continually supplied to a mass spectrometer that comprises the mass filter.

The range of mass to charge ratios may be varied such that once step (ii) has been repeated said plurality of times, the mass filter has been scanned over a total range of mass to charge ratios sufficient to transmit multiple different ion species, such as a total range of mass to charge ratios having a width of, for example, ≥2 Da, ≥5 Da, ≥10 Da, ≥15 Da, ≥20 Da, ≥30 Da, ≥40 Da, or ≥50 Da.

The method may comprise detecting ions transmitted by the mass filter during said single experimental run, or ions derived therefrom, so as to obtain a mass spectrum.

The third aspect of the present invention also provides a mass spectrometer comprising: a mass filter having electrodes; at least one voltage supply for applying voltages to the electrodes so as to provide the mass filter with a mass transmission window; and control circuitry configured to control the mass spectrometer to: (i) supply ions towards the mass filter; and (ii) repeatedly scanning the mass transmission window across a range of mass to charge ratios that has a width of less than 1 Da.

The mass spectrometer according to the third aspect may be configured to perform any of the methods described herein in relation to the third aspect.

From a fourth aspect the present invention provides a method of mass spectrometry comprising: (i) mass filtering ions using a mass filter having a mass transmission window; (ii) varying the width of the mass transmission window whilst the centre of the mass transmission window is maintained at a constant mass to charge ratio value.

Step (ii) comprises varying the width of the mass transmission window between a minimum width and a maximum width, optionally multiple times. The minimum width and/or maximum width may have a width of less than 1Da, such as ≤0.5 Da, ≤0.4 Da, ≤0.3 Da, ≤0.2 Da, or ≤0.1 Da.

Step (ii) is performed during a single experimental run, such as over a period during which ions are substantially continually supplied to the mass filter and/or during which analyte is continually supplied to a mass spectrometer that comprises the mass filter.

Step (ii) may be performed over a time period and ions transmitted by the mass filter during said time period, or ions derived therefrom, are detected so as to obtain mass spectral data; and wherein the mass spectral data is summed or averaged.

The method may comprise associating the summed or averaged mass spectral data with a mass to charge ratio within said window. For example, the mass spectral data may be associated with the value of said constant mass to charge ratio.

It will be appreciated that the mass transmission window is set by selecting the voltages that are applied to electrodes of the mass filter, i.e. RF and/or DC voltages.

The step of varying the width of the window may be performed by varying the amplitudes of RF and/or DC voltages applied to electrodes of the mass filter.

The method may comprise selecting a target mass to charge ratio that is desired to be transmitted by the mass filter and then performing steps (i) and (ii), wherein said target mass to charge ratio remains within the window during step (ii).

For example, the target mass to charge ratio may be said constant mass to charge ratio.

The method may form part of a multiple reaction monitoring experiment for analysing a target ion of interest having said target mass to charge ratio, and wherein said steps (i) and (ii) are performed in order to cause the mass filter to transmit the target ion of interest.

Alternatively, step (ii) may be repeated a plurality of times, wherein the value of the constant mass to charge ratio is varied each time that step (ii) is performed.

Step (ii) maybe repeated said plurality of times during a single experimental run, such as over a period during which ions are substantially continually supplied to the mass filter and/or during which analyte is continually supplied to a mass spectrometer that comprises the mass filter.

The value of the constant mass to charge ratio may be varied each time that step (ii) is performed such that once step (ii) has been repeated said plurality of times, the mass filter has been scanned over a total range of mass to charge ratios sufficient to transmit multiple different ion species, such as a total range of mass to charge ratios having a width of, for example, ≥2 Da, ≥5 Da, ≥10 Da, ≥15 Da, ≥20 Da, ≥30 Da, ≥40 Da, or ≥50 Da.

The method may comprise detecting ions transmitted by the mass filter during said single experimental run, or ions derived therefrom, so as to obtain a mass spectrum.

The fourth aspect of the present invention also provides a mass spectrometer comprising: a mass filter having electrodes; at least one voltage supply for applying voltages to the electrodes so as to provide the mass filter with a mass transmission window; and control circuitry configured to control the mass spectrometer to: (i) supply ions towards the mass filter; and (ii) vary the width of the mass transmission window whilst the centre of the mass transmission window is maintained at a constant mass to charge ratio value.

The mass spectrometer according to the fourth aspect may be configured to perform any of the methods described herein in relation to the fourth aspect.

### BRIEF DESCRIPTION OF THE DRAWINGS

Various embodiments of the present invention will now be described, by way of example only, and with reference to the accompanying drawings in which:

FIGS. 1A to 1D show how a species of ions having a single axial kinetic energy oscillate as they are transmitted through a mass filter, when different voltages are applied to the mass filter;

FIG. 2 shows mass spectral data detected by scanning the mass filter when the ions being analysed have a single axial kinetic energy;

FIG. 3 shows ions having a wide range of axial kinetic energies being transmitted through the mass filter;

FIG. 4 shows mass spectral data detected by scanning the mass filter when the ions being analysed have a wide range of axial kinetic energies;

FIGS. 5A-5B show ions having a narrow range of axial kinetic energies being transmitted through a mass filter when different voltages are applied to it;

FIGS. 6A and 6B correspond to FIG. 4 and FIG. 2, respectively, illustrate how intensity values change with small changes in mass to charge ratio;

FIG. 7 shows a schematic of a mass spectrometer according to an embodiment of the present invention;

FIGS. 8A to 8C show mass spectral data illustrating the improvements provided by embodiments of the present invention;

FIG. 9. shows a simulated mass peak exhibiting peaks and troughs, in a similar manner to FIG. 2; and

FIG. 10 shows three mass peaks obtained using a mass filter having mass transmission windows of three different widths.

### DETAILED DESCRIPTION

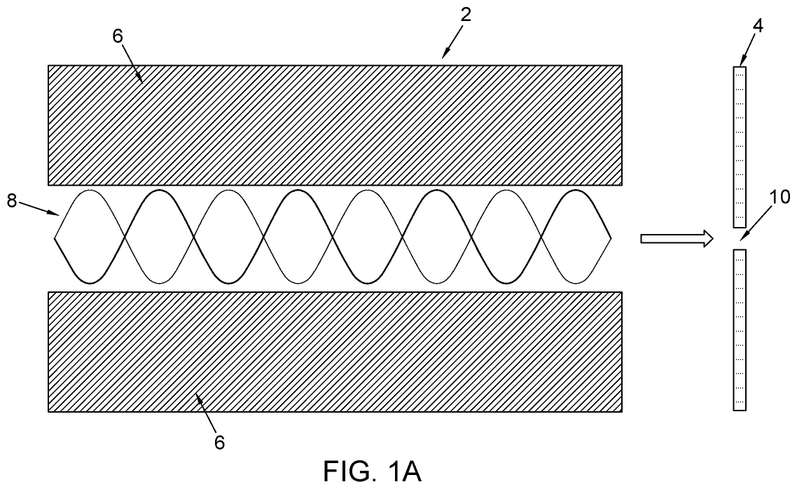

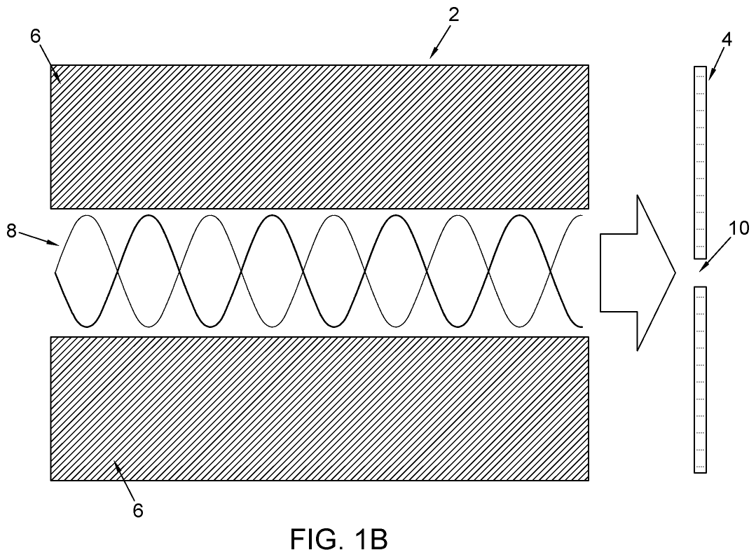

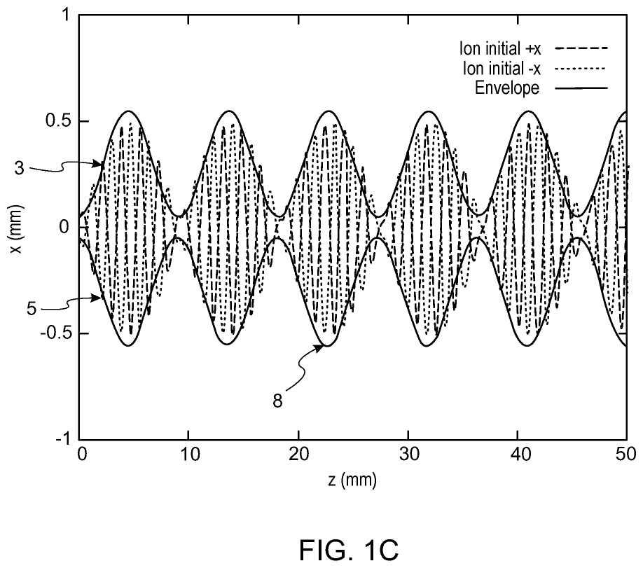

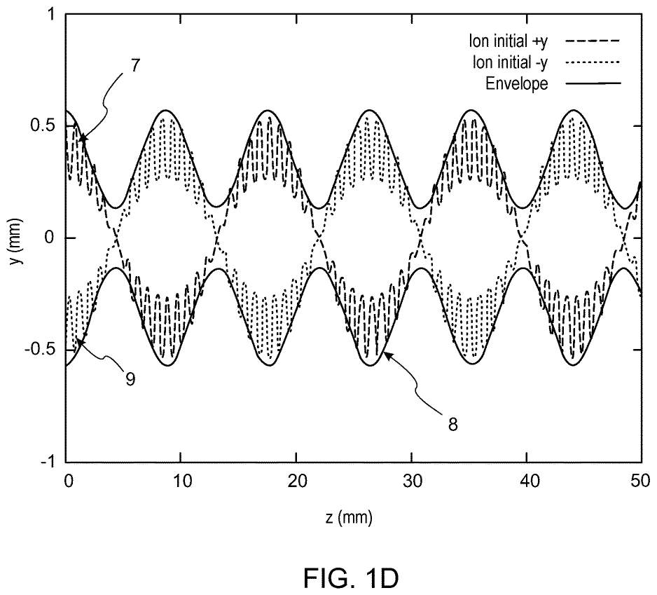

FIGS. 1A and 1B each show a schematic of a DC resolving quadrupole rod set mass filter 2 according to an embodiment of the invention, followed by a downstream apertured electrode 4. The mass filter 2 has quadrupole rod electrodes 6 to which RF and DC voltages are applied. These voltages cause ions having a certain range of mass to charge ratios, within a range known as a mass transmission window, to be radially confined in the mass filter so that these ions can be transmitted from the entrance to the exit of the mass filter. Ions having mass to charge ratios outside of this range have unstable trajectories in the mass filter and hence are not transmitted to the exit of the mass filter. The RF and DC voltages may be varied with time so that different ranges of mass to charge ratio are able to be transmitted by the mass filter at different respective times, i.e. such that the mass transmission window is moved. For example, the mass transmission window of the mass filter may be scanned by progressively stepping upwards or downwards the amplitudes of the RF and DC voltages that are applied to the mass filter. The ratio of the amplitudes of the RF and DC voltages may be maintained constant during the scanning of the mass filter. Each time that the amplitudes of the RF and DC voltages are stepped to new values, the amplitudes may be maintained constant for a period of time known as a dwell time before the amplitudes are stepped again.

As described above, ions having mass to charge ratios that are within the mass transmission window of the mass filter are radially confined by the mass filter. These ions oscillate radially between the electrodes as they travel along the longitudinal, central axis of the mass filter, as will be described in more detail in relation to FIGS. 1C and 1D.

FIG. 1A shows how the maximum amplitude of oscillation 8 of ions varies as a function of distance along the ion guide for a single ion species having the same mass to charge ratio, the same axial kinetic energy along the central axis, and the same starting position at the upstream end of the mass filter. In other words, FIG. 1A shows the envelope shown in FIGS. 1C and 1D. The envelope 8 may be considered to have nodes, at which the ions have an amplitude of oscillation that is close to the central axis of the mass filter, and anti-nodes at which the amplitude of oscillation of the ions is at a maximum radial distance from the central axis.

FIGS. 1C and 1D show an example of the trajectories of ions that are stable within the mass filter. FIG. 1C shows the amplitude of the radial oscillation of the ions about the central axis in the dimension between one pair of electrodes of the quadrupole mass filter (i.e. the x-dimension), as a function of axial distance along the mass filter. More specifically, FIG. 1B shows the trajectories 3 of ions that enter the mass filter travelling in the +x direction, and also the trajectories 5 of ions that enter the mass filter travelling in the −x direction. As can be seen from FIG. 1C, the amplitude with which the ions oscillate varies as they travel along the mass filter. Although the detailed ion motion can be complicated, and the amplitude of any given ion will depend on its starting conditions when it enters the mass filter (such as its spatial position, velocity and the phase of the RF voltage), the envelope 8 around these amplitudes may be considered to have nodes and anti-nodes arranged at a particular spatial frequency.

Similarly, FIG. 1D shows the amplitude of the radial oscillation of the ions about the central axis in the dimension between the other pair of electrodes of the quadrupole mass filter (i.e. the y-dimension), as a function of axial distance along the mass filter. More specifically, FIG. 1D shows the trajectories 7 of ions that enter the mass filter travelling in the +y direction, and also the trajectories 9 of ions that enter the mass filter travelling in the −y direction. As already described in relation to FIG. 1C, the amplitude with which the ions oscillate varies as they travel along the mass filter and the envelope 8 around these amplitudes may be considered to have nodes and anti-nodes arranged at said particular spatial frequency.

It will be appreciated that if a node is located at the exit of the mass filter, as shown in FIG. 1A, then a relatively large proportion of the ions will exit the mass filter when they have substantially no radial displacement from the central axis. In such a scenario a relatively high proportion of the ions will be transmitted through the aperture 10 of the downstream apertured electrode 4, since the central axis through the aperture is aligned with the central axis of the mass filter.

In contrast, as shown in FIG. 1B, if an anti-node is located at the exit of the mass filter, then a relatively large proportion of the ions will exit the mass filter when they have a relatively large radial displacement from the central axis of the mass filter. As such, only a relatively low proportion of the ions will be transmitted through the downstream aperture 10, and the remaining ions will be lost to the system, such as by striking the electrode 4 in which the aperture is formed.

The frequency with which the ions oscillate radially, and hence the spacing of the nodes and anti-nodes in the envelope 8 (assuming that the ions have the same velocity in the axial direction), depends on the values of the parameters a and q in the Mathieu stability diagram that the ion is at. In other words, this depends on the amplitudes of the RF and DC voltages that are applied to the mass filter and also on the mass to charge ratio of the ion (assuming the mass filter has a constant inscribed radius and a constant RF frequency). When the mass transmission window of a DC resolving quadrupole mass filter is scanned with time so as to be capable of transmitting different mass to charge ratios at different times, the amplitudes of the RF and DC voltages are varied. Therefore, the values of the parameters a and q will also vary, causing the frequency with which the ions oscillate radially to vary, and thus causing the spacing between the nodes and anti-nodes to vary. As such, the average radial displacement of the ions at the point where the ions leave the mass filter, and therefore the proportion of ions transmitted through the downstream aperture, will vary as the mass filter is scanned. It will therefore be appreciated that, if the ions have substantially the same mass to charge ratio and the same axial kinetic energy, then the proportion of the ions that are transmitted through the aperture will vary in an upwards and downwards manner cyclically as the mass filter is scanned.

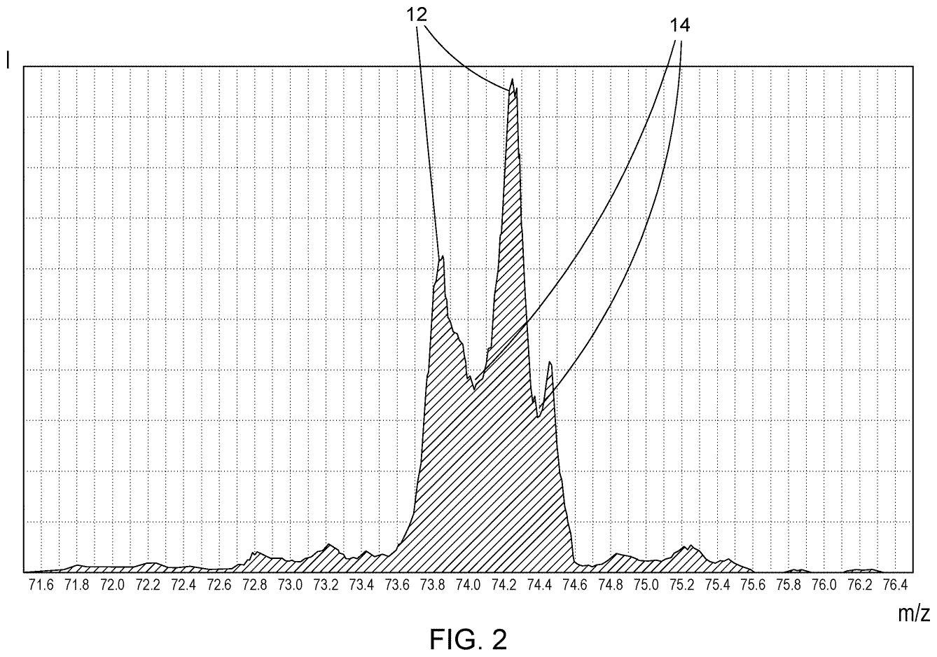

FIG. 2 shows an example of mass spectral data detected for ions of a single species by scanning a mass filter in the manner described above in relation to FIGS. 1A-1B. As usual, the y-axis represents the intensity of the ions detected, whereas the x-axis represents mass to charge ratio. As only a single ion species is transmitted in this example a gaussian profile for the mass peak would be expected. However, the mass spectral data appears to show multiple mass peaks. This is due to the transmission level of the ions varying as the mass filter is scanned, as described above. The relatively high intensity portions 12 in the mass spectral data correspond to the ions being transmitted with a relatively high transmission level (i.e. when a node of the envelope is at the exit of the mass filter), whereas the relatively low intensity troughs 14 corresponds to the ions being transmitted with a relatively low intensity (i.e. when an anti-node is at the exit of the mass filter).

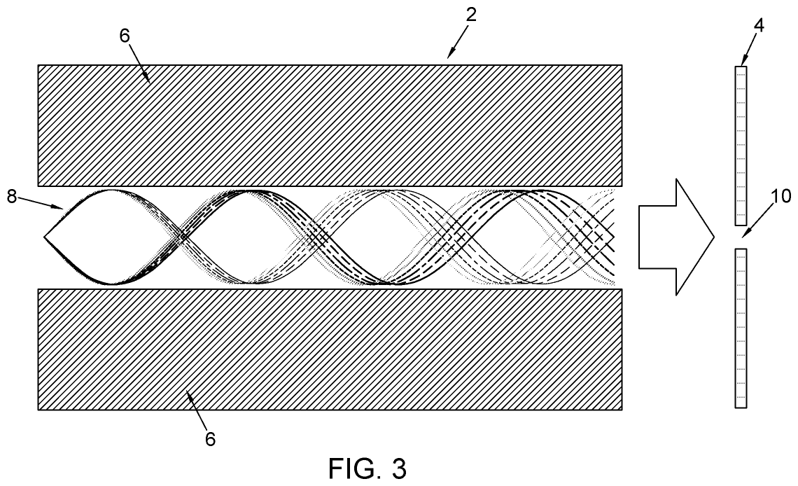

Even though it is conventionally desired for ions to have the minimal energy spread possible so that the mass filter has a high mass resolution, in reality the ions passing through the mass filter do not all have the same axial energy along the central axis. Rather, the ions have a spread of axial energies. For example, ions may typically be collisionally cooled to an average kinetic energy of approximately 0.5 eV prior to entering the mass filter. Such ions typically have an average axial kinetic energy of 0.5 eV and an axial kinetic energy spread of up to 1 eV, at the point that the enter the mass filter. In such instances, the spread of axial kinetic energies of the ions is relatively large in the direction along the central axis of the mass filter. Although ions of the same mass to charge ratio will oscillate radially within the mass filter at the same frequency, ions having different axial kinetic energies will have different transit times through the mass filter and so will reach the exit of the mass filter having different radial displacements from the central axis of the mass filter. In other words, it may be considered that the ions having different axial kinetic energies have different envelopes 8, where the nodes of those envelopes are at different spacings along the mass filter, e.g. as shown in FIG. 3.

FIG. 3 shows an embodiment corresponding to those in FIGS. 1A-1B, except wherein the ions have a relatively wide range of axial kinetic energies compared to their average axial kinetic energy. As can be seen, even though the ions have the same mass to charge ratio, ions having different axial kinetic energies have different envelopes 8, such that the nodes of these different envelopes can be considered to be located at different axial positions along the mass filter. Ions having different axial kinetic energies exit the mass filter at different respective radial displacements from the central axis. In fact, as the ions have a relatively wide range of axial kinetic energies relative to their average axial kinetic energy, the ions at the exit of the mass filter have a wide range of radial displacements from the central axis. As such, at any given time only a moderate proportion of the ions exiting the mass filter are transmitted through the downstream aperture 10, with the other ions being lost, e.g. by hitting the surface around the aperture. Provided that the ions have a relatively wide range of axial kinetic energies relative to their average axial kinetic energy, this will be true even as the mass transmission window of the mass filter is scanned.

For example, at any given moment, ions having a first axial kinetic energy may have a relatively small average radial displacement when they exit the mass filter and therefore a relatively high transmission level through the downstream aperture, whereas ions having a second, different axial kinetic energy may have a relatively high average radial displacement when they exit the mass filter and therefore a lower transmission level through the downstream aperture. At a subsequent time when the mass transmission window has been scanned so as to be capable of transmitting a new range of mass to charge ratios, ions having the first axial kinetic energy may have a relatively large average radial displacement when they exit the mass filter and therefore a relatively low transmission level through the downstream aperture, whereas ions having the second axial kinetic energy may have a relatively low average radial displacement when they exit the mass filter and therefore a higher transmission level through the downstream aperture. As such, the proportion of ions that is transmitted at any given time may remain relatively constant as the mass filter is scanned and so the mass peak detected for such ions does not suffer from significant peaks and troughs.

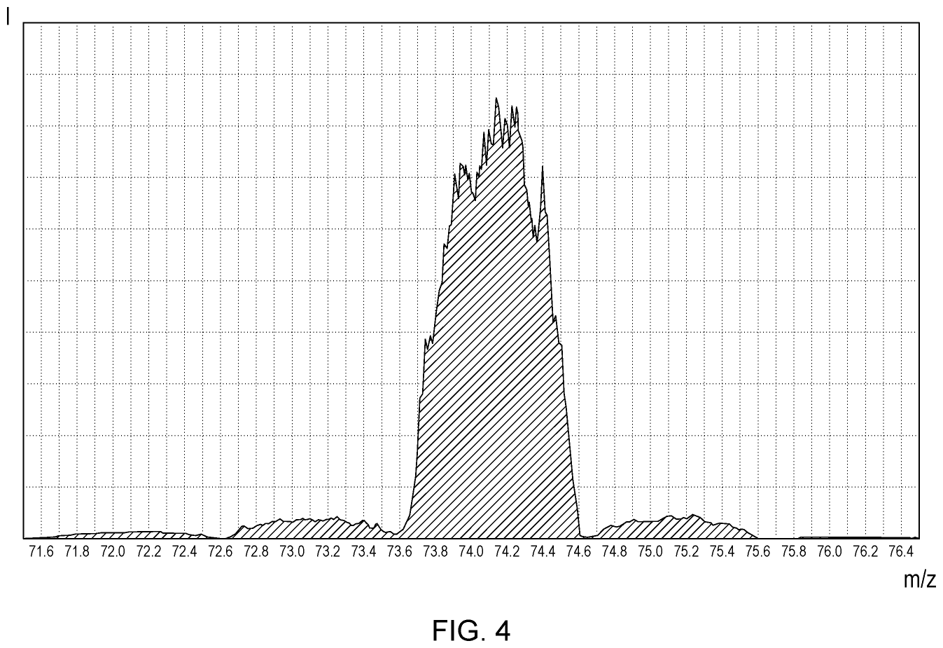

FIG. 4 shows an example of mass spectral data detected for a single ion species by scanning the mass filter, when the ions have a relatively wide range of axial kinetic energies relative to their average kinetic axial energy. It can be seen that the mass peak does not have the significant peaks 12 and troughs 14 shown in FIG. 2.

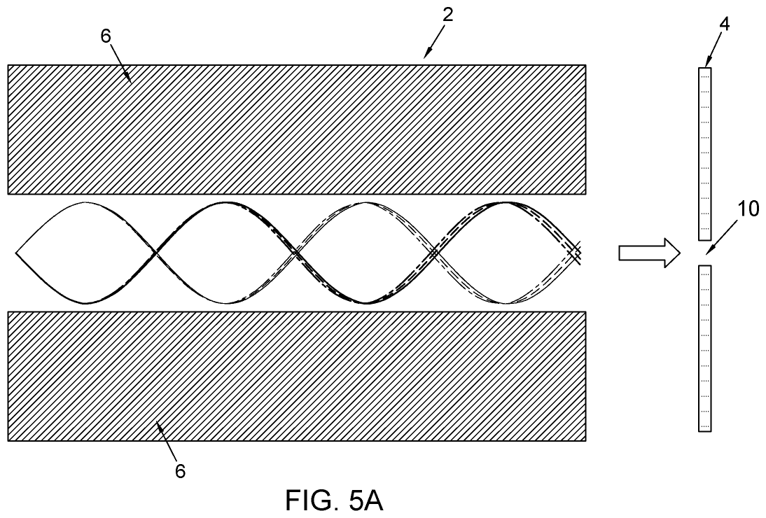

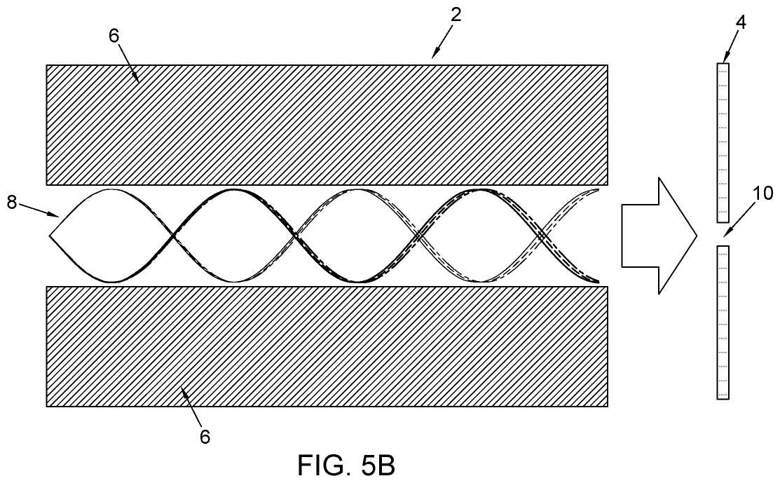

However, if the ions have a relatively small range of axial kinetic energies relative to their average axial kinetic energy, then the transmission level may vary as the mass filter is scanned, as will be described in relation to FIGS. 5A and 5B.

FIGS. 5A and 5B show an embodiment corresponding to that in FIG. 3, except wherein the ions have a relatively narrow range of axial kinetic energies relative to their average axial kinetic energy. As the ions have a relatively narrow range of axial kinetic energies relative to their average axial kinetic energy, the ions at the exit of the mass filter have a narrow range of radial displacements from the central axis. In other words, the ions having different axial kinetic energies may be considered to have different envelopes 8 that have nodes which are relatively close to each other in the axial direction.

As shown in FIG. 5A, when a certain combination of RF and DC voltages are applied to the mass filter, all of the ions will have a relatively low radial displacement from the central axis when they exit the mass filter, because the ions have only slightly different axial kinetic energies. In other words, the nodes of all of the envelopes 8 will be at, or relatively close to, the exit of the mass filter. As such, a large proportion of these ions will be transmitted through the downstream aperture. In contrast, as shown in FIG. 5B, when the mass filter is scanned so as to have a different combination of RF and DC voltages applied to it, all of the ions will have a higher radial displacement from the central axis when they exit the mass filter, because the ions have only slightly different axial kinetic energies. In other words, the anti-nodes of all of the envelopes 8 will be at, or relatively close to, the exit of the mass filter. As such, a lower proportion of the ions will be transmitted through the downstream aperture. Accordingly, if the ions have a relatively small range of axial kinetic energies relative to their average axial energy, then the detrimental effect described in relation to FIGS. 1-2 may occur.

Although ions of different mass to charge ratio are transmitted when the mass filter has different mass transmission windows, the ions that are transmitted during the mass transmission windows may radially oscillate within the mass filter at approximately the same frequency (when the ratio of the q and a parameters in the Matthieu stability diagram are maintained constant). However, as described above, ions having different axial kinetic energies will have different spacings between the nodes (and between the anti-nodes) in their envelopes. For example, ions having lower mass to charge ratios tend to have higher average kinetic energies, and so the spacings between the nodes (and between the anti-nodes) in their envelopes are relatively large and the detrimental effect described in relation to FIGS. 1-2 is more pronounced. Embodiments of the present invention recognise that, for ions having a relatively large spacing between the nodes (or anti-nodes), the ratio of the spread of kinetic energies to the average kinetic energy is required to be relatively high in order to mitigate the effect described in relation to FIGS. 1-2. In contrast, for ions having a smaller spacing between the nodes (or anti-nodes), the ratio of the spread of kinetic energies to the average kinetic energy may be controlled to be lower in order to mitigate the effect described in relation to FIGS. 1-2.

It is often desired to provide ions with a relatively high average axial kinetic energy for various reasons. As spectrometers are set up in a manner such that the spread of axial kinetic energies tends to remain approximately constant for all average axial kinetic energies, when the average axial kinetic energy is increased the spread of axial kinetic energies becomes a smaller proportion of the average axial kinetic energy. As such, increasing the average kinetic axial energy may cause the detrimental effect described in relation to FIGS. 1-2 to occur.

For example, it may be desired to provide the ions with axial kinetic energies that are above a threshold value, but also to keep the axial kinetic energies as low as possible, thus leading to a small range of axial kinetic energies as compared to the average axial kinetic energy. For instance, ions may be required to have axial kinetic energies above a threshold value to avoid effects caused by contamination building up on the electrodes of the mass filter over time. Such contamination may occur because ions that are filtered out by the mass filter strike its electrodes. Although the ions are neutralised when they hit the electrodes they can leave an electrically insulating deposit on the electrodes, upon which further ions can strike. This can lead to a build-up of electrical charge on the insulating deposit and therefore to a potential barrier forming. In order to minimise the effect of the potential barrier on the motion of the non-filtered ions through the mass filter, it may be desired to provide the ions with a minimum threshold axial kinetic energy. However, for a high mass resolution it is desired for the ions to experience as many cycles of the RF field of the mass filter as possible, and therefore for the ions to have the minimum axial kinetic energy possible, but above the threshold axial kinetic energy described above. As such, there is a tendency towards providing the ions such that they have only a small range of axial kinetic energies, and this can be problematic when the range is a relatively small proportion of the average axial kinetic energy for the reasons discussed above.

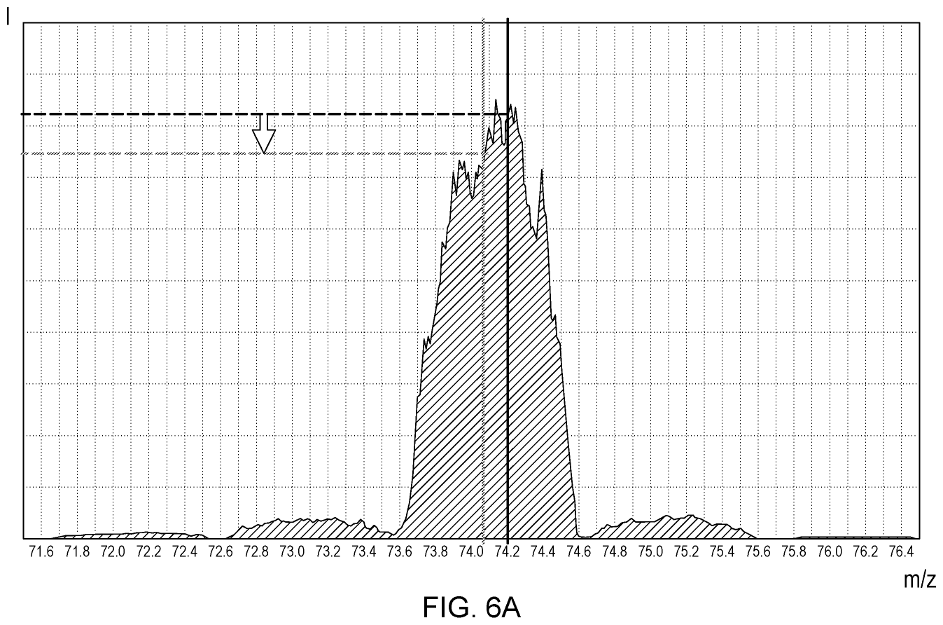

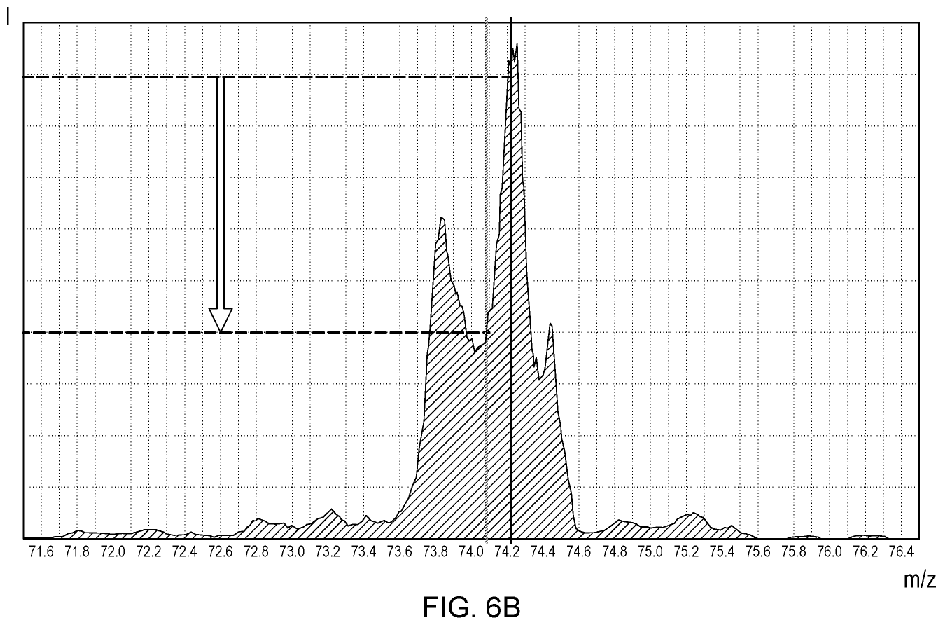

FIGS. 6A and 6B correspond to FIG. 4 and FIG. 2, respectively, and help further illustrate the problem encountered when increasing the average axial kinetic energy of the ions. FIG. 6B shows the mass spectral data obtained when the average axial kinetic energy of the ions has been increased by 3 eV as compared to the average axial kinetic energy of the ions used to obtain the mass spectral data show in FIG. 6A. The spread of the axial kinetic energies of the ions is substantially the same for FIGS. 6A and 6B, meaning that the spread of the axial kinetic energies is a larger proportion of the average axial kinetic energy for FIG. 6A than it is for FIG. 6B.

As illustrated by the vertical lines in FIG. 6A, if the underlying mass position drifts by a small amount, e.g. due to thermal effects, then the intensity of the detected ion signal changes by only a relatively small amount, as illustrated by the dashed horizontal lines. In contrast, as illustrated by the vertical lines in FIG. 6B, if the underlying mass position drifts by a small amount then the intensity of the detected ion signal can change by a relatively large amount, as illustrated by the dashed horizontal lines.

The inventors have recognised the problems described above and that it may be desirable to provide the ions with a spread of axial kinetic energies that is above a threshold proportion of the average axial kinetic energy, such that the level of transmission of the ions downstream of the mass filter remains relatively constant across a mass peak, e.g. even when the mass transmission window of the mass filter is scanned.

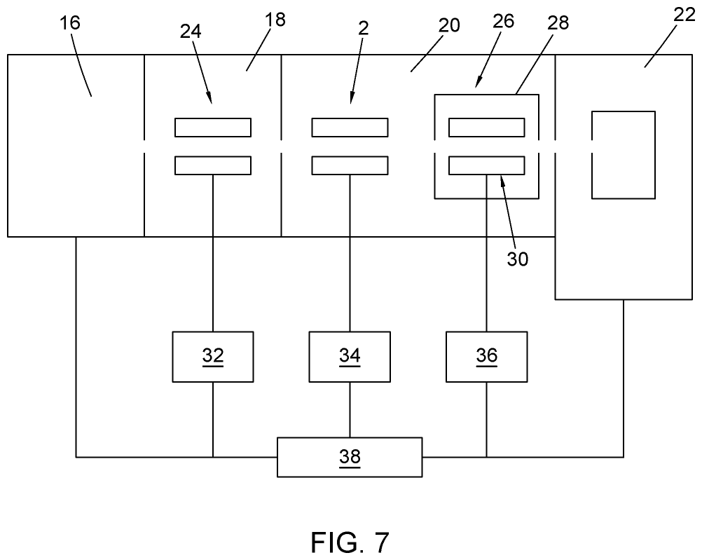

FIG. 7 shows a schematic of a mass spectrometer according to an embodiment of the present invention. The spectrometer comprises an ion source 16, a first vacuum chamber 18 that is pumped down to a first pressure in use, a second vacuum chamber 20 that is pumped down to a lower pressure in use, and a third vacuum chamber 22 that is pumped down to an even lower pressure in use. The first vacuum chamber 18 comprises an ion guide 24. The second vacuum chamber 20 comprises a DC resolving quadrupole mass filter 2, which may be operated in the manner described hereinabove. The second vacuum chamber may also comprise a fragmentation or reaction cell 26. The cell 26 may have a housing 28 with entrance and exit openings. The housing 28 may be configured to maintain the region therein at a higher pressure than the region in the rest of the second vacuum chamber 20, e.g. for use in collisional induced fragmentation of ions passing into the cell. For example, the cell 26 may be supplied with a gas so as to maintain it at the higher pressure. Alternatively the cell 26 may be supplied with reactant molecules or ions for reacting with analyte ions entering the cell, e.g. so as to cause fragmentation of the analyte ions or other reactions with the analyte ions so as to produce product ions. The cell 26 may comprise an ion guide 30 for guiding analyte ions from the entrance to the exit of the cell 26, and/or for guiding fragment or product ions that are generated from the analyte ions within the cell 26 to the exit of the cell. The third vacuum chamber 22 may comprise a mass analyser, such as a time of flight mass analyser.

In use, analyte ions are generated in the ion source 16 and pass through an entrance orifice into the first vacuum chamber 18, where they may be received in the ion guide 24. A voltage supply 32 applies one or more voltages, such as an RF voltage, to the electrodes of the ion guide 24 so as to radially confine ions therein. The first vacuum chamber may be maintained at a relatively high pressure such that the ions are collisionally cooled via collisions with background gas molecules in the first vacuum chamber. The ions are urged in the downstream direction, e.g. by a gas flow and/or electric field, so as to pass through a differential pumping aperture in the wall between the first and second vacuum chambers 18,20. The ions then enter the mass filter 2, which has RF and DC voltages applied to its electrodes by voltage supplies 34 so as to provide the mass filter with a mass transmission window. Ions having a mass to charge ratio within the mass transmission window are transmitted through the mass filter and out of its exit, whereas ions having a mass to charge ratio outside of the mass transmission window are filtered out by the mass filter.

The ions that are transmitted to the exit of the mass filter then pass downstream and may enter the entrance orifice into the fragmentation or reaction cell 26. These ions are guided through the cell 26 and to the exit orifice by the ion guide 30 therein. A voltage supply 36 applies one or more voltages, such as an RF voltage, to the electrodes of the ion guide 30 so as to radially confine ions therein. If the fragmentation or reaction cell is activated then at least some of the ions are fragmented or reacted so as to form fragment or product ions. For example, if the cell 26 is a collisional induced dissociation (CID) cell then the ions may be accelerated into or within the cell 26 so as to fragment. Alternatively, if the cell 26 is a reaction cell then the ions may react with a reactant in the cell so as to fragment or produce other product ions, such as adduct ions. On the other hand, if the fragmentation or reaction cell 26 is deactivated then the analyte ions pass therethrough and out of the exit orifice substantially without any fragmentation or reactions occurring.

The ions that exit the cell 26 may then pass to a detector or mass analyser 23 that enables them to be mass analysed.

The amplitudes of the DC and RF voltages that are applied to the mass filter 2 so as to generate the mass transmission window may be stepped with time so that the values of mass to charge ratios that are able to be transmitted by the mass filter vary with time. For example, the mass transmission window of the mass filter may be scanned by progressively stepping upwards or downwards the amplitudes of the RF and DC voltages that are applied to the mass filter. The ratio of the amplitudes of the RF and DC voltages may be maintained constant during the scanning of the mass filter. Each time that the amplitudes of the RF and DC voltages are stepped to new values, the amplitudes may be maintained constant for a period of time, known as a dwell time, before the amplitudes are stepped again. The spectrometer comprises control circuitry that controls the various ion-optical devices and voltage supplies discussed above.

However, as described above, it has been recognised that during each dwell time, if the ions that are transmitted by the mass filter 2 have a relatively narrow spread of axial kinetic energies relative to their average axial kinetic energy then the proportion of ions that are transmitted through the spectrometer (e.g. through the entrance orifice in cell 26) can vary as the mass filter is scanned. It has also been recognised that it may be desirable to increase the spread of the axial kinetic energies of the ions that are transmitted by the mass filter 2 during each dwell time, e.g. such that the transmission level of the ions downstream of the mass filter is relatively constant as the mass filter is scanned.

The spread of the axial kinetic energies of the ions may be increased prior to the ions entering the mass filter and/or within the mass filter itself, and may be achieved by applying an electric field to the ions. For example, the ions may be subjected to an electric field that has an amplitude in the axial direction that is modulated so as to increase the spread of the axial energies of the ions. The electric field may be generated by DC voltages.

For example, the ions may travel through a region across which there is a DC potential difference, on their way to the mass filter 2, and the DC potential difference may be modulated with time. As an approximation, the ions will pick up the energy of the potential difference that they pass through. As such, ions entering the region at different times will experience different DC potential differences and hence will be provided with different kinetic energies.

Referring to FIG. 7, for example, a DC voltage applied to the ion guide 24 and/or mass filter 2 may be modulated so that a DC potential difference between the ion guide 24 and mass filter 2 is modulated with time. Ions that exit the ion guide 24 at different times will therefore be provided with different axial kinetic energies and will enter the mass filter 2 having those different kinetic energies.

The RF and DC voltages applied to the mass filter 2 are fixed during any given dwell time, so that the mass filter has a mass transmission window that is only capable of transmitting a certain range of mass to charge ratios. Ions of a specific mass to charge ratio will radially oscillate in the mass filter at a certain frequency as they travel downstream through the mass filter. Embodiments modulate the DC potential difference over a range of values during each dwell time, so that the ions transmitted by the mass filter during that dwell time have different axial kinetic energies and therefore have different transit times from the entrance to the exit of the mass filter. As such, over the duration of any given dwell time, ions will exit the mass filter over a relatively large range of radial displacements from the central axis of the mass filter. Accordingly, when the mass filter is scanned so that the mass transmission window is held at different mass to charge ratio positions at different dwell times, the proportion of ions that is able to be transmitted through an orifice downstream of the mass filter (e.g. the entrance orifice to cell 26), is relatively constant for all of the dwell times. Therefore scanning the mass filter does not cause significantly different proportions of ions to be transmitted through the downstream orifice during different dwell times.

The modulation may involve performing a cycle in which the DC potential difference is varied between a maximum value and a minimum value. During the cycle the DC potential difference may be varied in a continuous and progressive manner between the maximum and minimum values (e.g. in a linear manner), or it may be discontinuously stepped between a plurality of values. Desirably, the modulation may involve performing a plurality of such cycles during each dwell time. This helps avoid different average transmission levels for different dwell times. For example, it may be desirable to provide ≥5, or ≥10 cycles during each dwell time. For instance, if each dwell time has a duration of 1 ms, then it may be desirable to modulate the DC potential difference at a frequency of ≥10 KHz.

Although the axial kinetic energy of the ions has been described as being modulated by modulating the DC potential difference between the mass filter 2 and an upstream ion guide 24, it is contemplated that the axial kinetic energy may be modulated in other manners. For example, the axial kinetic energy of the ions may be modulated within the mass filter 2 and/or ion guide 24, rather than between them. This may be achieved, for example, by providing a DC potential difference along the mass filter 2 and/or ion guide 24 and modulating that DC potential difference. The mass filter and/or ion guide may comprise axially segmented electrodes and different DC voltages may be applied to different segments in order to form the axial DC potential difference. The DC voltage applied to each segment may be varied with time so as to perform the modulation discussed. Alternatively, rod electrodes may be provided in the mass filter and/or ion guide that are angled to the central axis so as to form the axial DC potential difference and the DC voltage applied to those electrodes may be varied with time so as to modulate the axial DC potential difference.

Alternatively or additionally to modulating the DC potential difference, the ions may be provided with different axial kinetic energies by repeatedly travelling one or more DC potentials in the downstream direction along an axial region of the spectrometer. In order to modulate the energy of the ions during each dwell time, the speed at which the one or more DC potential is travelled along the axial region may be varied during each dwell time. For example, ions that enter the axial region at one time may be urged downstream by the one or more DC potential at a first speed so as to have a relatively low axial kinetic energy, whereas ions that enter the axial region at another time may be urged downstream by the one or more DC potential at a second different speed so as to have a higher axial kinetic energy. The speed of the DC potential may be modulated during each dwell time by performing a cycle in which the speed of the DC potential is varied between a maximum value and a minimum value, or vice versa. Desirably, the modulation may involve performing a plurality of such cycles during each dwell time. The axial region may be an axial region of the mass filter 2 and/or an axial region of the ion guide 24 and/or of an axial region between the ion guide 24 and mass filter 2.

Although the axial kinetic energy of the ions has been described as being modulated by modulating electrical potentials, it is contemplated that the axial kinetic energy may be modulated in other manners. For example, a gas flow may be provided through a region for urging the ions either in the upstream or downstream axial direction.

The velocity of the gas flow may be modulated such that ions passing through the region at different times will experience different gas flow velocities and hence will exit the region with different kinetic energies.

Alternatively or additionally, the ions may pass through a region in which the gas pressure is modulated such that ions passing through the region at different times will experience different gas pressures and hence will exit the region with different kinetic energies.

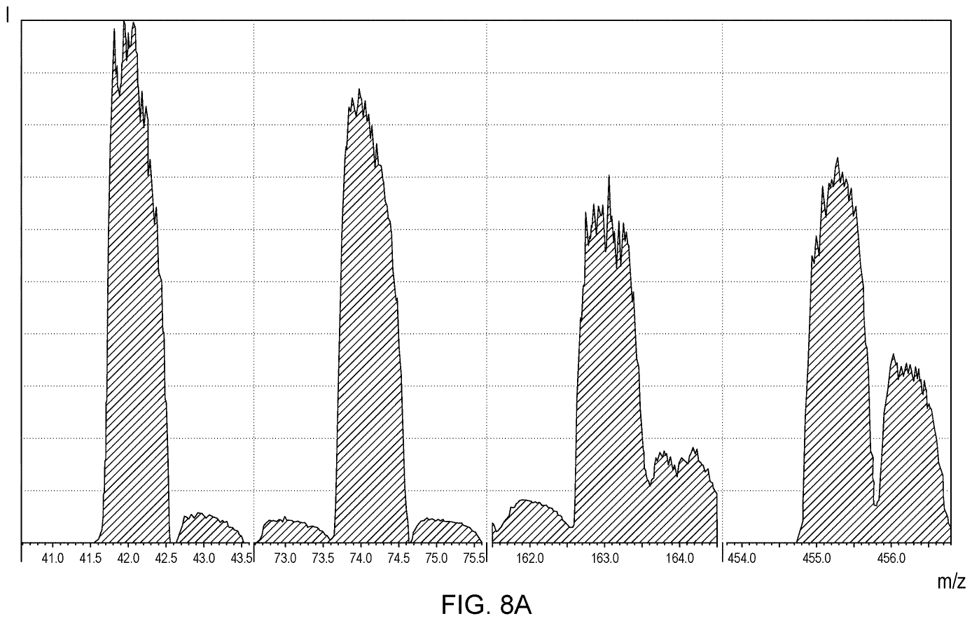

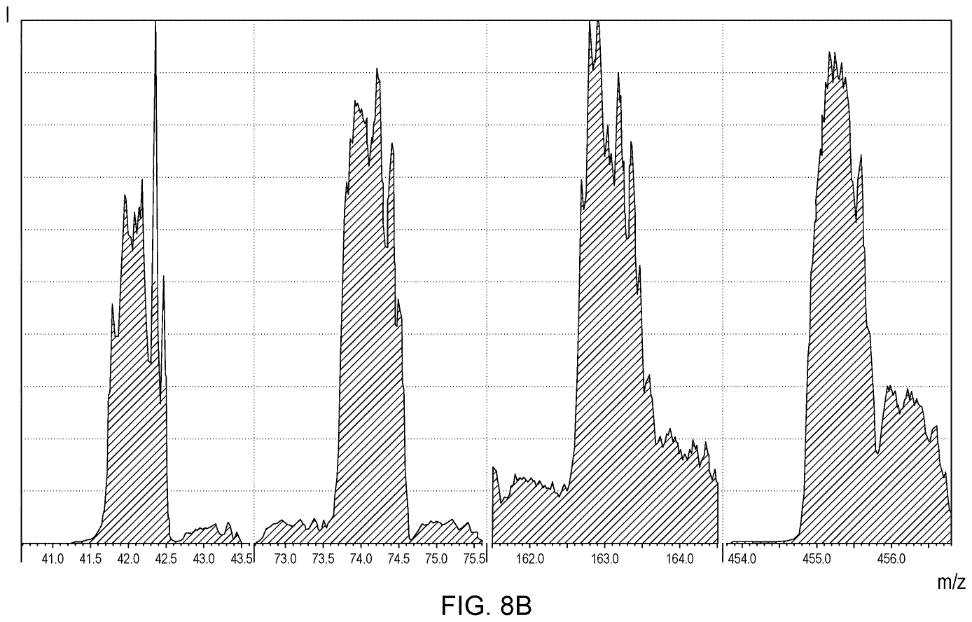

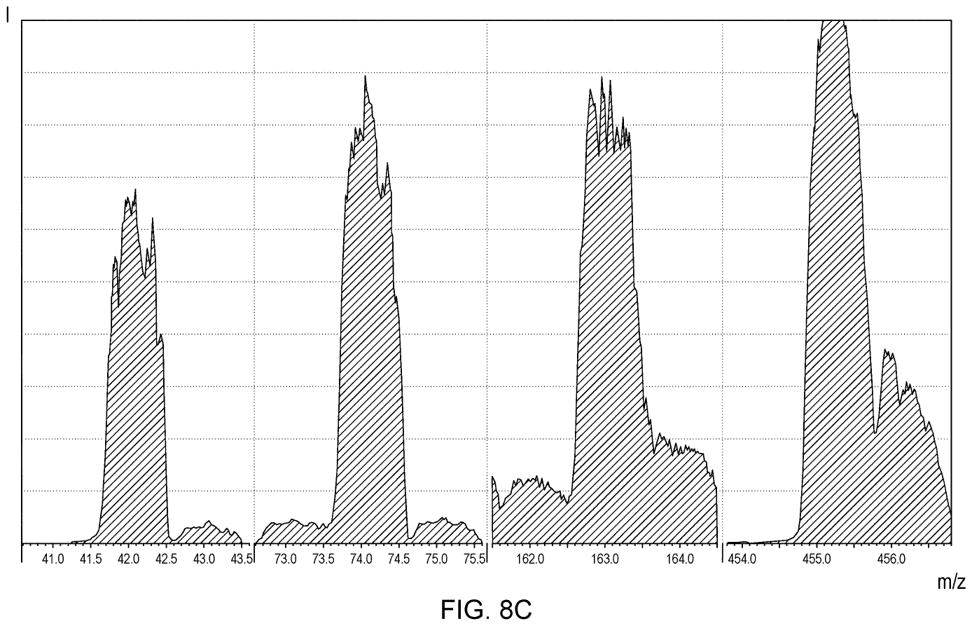

FIGS. 8A to 8C show mass spectral data illustrating the improvements provided by embodiments of the present invention.

FIG. 8A shows mass spectral data indicating how the intensity of the ion signal varies as a mass filter 2 is scanned over four different mass ranges, when the ions being analysed by the mass filter have a relatively low average axial kinetic energy and a spread of axial kinetic energies that is a relatively high proportion of the average axial kinetic energy. In this example, the four mass ranges correspond to mass peaks centred at 42.1 Da, 74.1 Da, 183.0 Da and 455.3 Da. As can be seen, each of the mass peaks has a relatively gaussian shape and its intensity does not vary significantly for small variations in mass to charge ratio from the centre of the peak. However, as described above, it may be undesirable to mass analyse ions having such a low average axial kinetic energy, e.g. because their transmission is more easily affected by the electrical charge that can build up on contaminated electrodes of the mass filter.

FIG. 8B shows mass spectral data for an experiment corresponding to that used to obtain the data in FIG. 8A, except wherein the average axial kinetic energy of the ions being mass analysed was 2 eV higher (i.e. the spread of axial kinetic energies is substantially the same in FIGS. 8A and 8B). It can be seen by comparing FIGS. 8A and 8B that increasing the average axial kinetic energy of the ions, without also significantly increasing the spread of axial kinetic energies, causes peaks and troughs to appear in each of the mass peaks. This is particularly prominent for the left-most mass peak (centred at 42.1 Da) in FIG. 8B, which shows a significant variation in intensity with only a small change in mass position from the centre of the mass peak. Although the FWHM of the mass peak has not changed for the low masses as the average axial kinetic energy is increased, the appearance of peak shape aberrations means that mass drift can cause a large variation in the signal intensity. This can be particularly problematic, for example, in Multiple reaction monitoring (MRM) or Selective Reaction Monitoring (SRM).

FIG. 8C shows mass spectral data for an experiment corresponding to that used to obtain the data in FIG. 8B, i.e. for ions having substantially the same average axial kinetic energy as FIG. 8B, except wherein prior to mass analysis in the mass filter the ions were subjected to a DC field that was modulated in the manner described above at a frequency of 10 kHz so that the spread of the axial kinetic energies of the ions was +/−1.2 eV relative to the average axial kinetic energy. As can be seen by comparing FIGS. 8B and 8C, increasing the spread of the axial kinetic energies of the ions in this manner significantly smooths the intensity profile for each of the mass peaks, i.e. reduces the presence of the peaks and troughs in each of the mass peaks. It will therefore be appreciated that this technique enables the mass analysis of ions having a higher average axial energy (e.g. so as to reduce or avoid the effects of surface charging in the mass filter), whilst maintaining the repeatability of the mass analysis for small changes in mass to charge ratio.

It is generally seen as undesirable to increase the energy spread of ions prior to mass analysis because this decreases the mass resolution of the ions, where mass resolution is defined as mass to charge ratio divided by the mass to charge ratio peak width. However, the inventors have recognised that the spread of the axial kinetic energies of the ions can be increased at relatively low mass to charge ratios without being detrimental to the mass resolution of a quadrupole mass analyser or quadrupole mass filter, because although such devices are typically operated so that they have a high mass resolution at a high mass to charge ratio, they tend to have a lower mass resolution for lower mass to charge ratios. More specifically, quadrupole mass filters and mass analysers are typically operated so as to have a mass transmission window that remains a constant size as it is scanned. Therefore, although such devices will have a high mass resolution when transmitting high mass to charge ratio ions, they will have a lower mass resolution when transmitting lower mass to charge ratio ions. For example, if the mass transmission window is set to have a width of 0.5 Da, then the mass resolution for a 1000 Da ion will be 1000/0.5=2000, whereas the mass resolution for a 100 Da ion will only be 100/0.5=200.

The inventors have recognised that as the mass resolution of a mass filter or mass analyser is relatively low for low mass to charge ratios, the average energy of these ions and their energy spread can both be increased without impacting on the mass resolution that is achieved by the mass filter or mass analyser. In contrast, as the mass resolution of a mass filter or mass analyser is relatively high for high mass to charge ratios, it is desirable for the average kinetic energy of these ions and their energy spread to be minimised so as to maintain the high mass resolution that is able to be achieved by the mass filter or mass analyser. The modulation may therefore be applied in a mass to charge ratio dependent manner.

Although the present invention has been described with reference to various embodiments, it will be understood by those skilled in the art that various changes in form and detail may be made without departing from the scope of the invention as set forth in the accompanying claims.

For example, the mass filter may have a post-filter at its downstream end.

The mass filter need not be a DC resolving mass filter. For example, the mass filter may be an RF-only mass filter.

Although embodiments of a quadrupole mass filter have been described, the invention extends to a quadrupole mass analyser, i.e. where an ion detector detects ions transmitted by the quadrupole and determines the mass to charge ratio of the detected ions based on the voltages applied to the quadrupole at the time the detected ions were transmitted by it.

Although embodiments have been described in which the ions are transmitted through an aperture in an electrode or other surface, it is contemplated that the aperture may be an acceptance aperture defined by the electric fields of a device downstream of the mass filter.

The mass filter or mass analyser may comprise a quadrupole rod set having continuous rod electrodes or alternatively the quadrupole electrodes may be axially segmented, e.g. such as by comprising plate electrodes having their major surfaces arranged in the plane orthogonal to the central axis.

Additionally, or alternatively, the cross-sectional shape of each of the quadrupole electrodes, in the plane orthogonal to the central axis, may be circular, hyperbolic, an arcuate shape or any other shape.

Although various embodiments have been described, it will be appreciated that the spectrometer need not have all of the components shown or may have different components. For example, the spectrometer may have fewer or a greater number of vacuum chambers than described above. Additionally, or alternatively, the spectrometer need not have a fragmentation or reaction cell. Additionally or alternatively, alternative types of mass analyser may be used instead of the TOF mass analyser and such a mass analyser need not be provided in its own vacuum chamber. For example, the mass spectrometer could be a tandem quadrupole mass spectrometer in which the mass filter 2 is used as the mass filter that selectively transmits precursor ions, or as the mass filter that selectively transmits the product ions.

Although the problem of peaks 12 and troughs 14 appearing within a mass peak has been described in the context of scanning a mass filter, e.g. as shown in FIG. 2, it will be appreciated that the same problem arises even if the mass filter is not scanned. For example, during an experiment, such as a Multiple Reaction Monitoring (MRM) experiment, the mass filter may be parked so that its mass transmission window is at a fixed location within the mass peak of an ion species. If the mass filter is parked such that the mass transmission window is primarily located within one of the peaks 12 in the mass peak then an ion signal with a high intensity would be transmitted, whereas if the mass filter is parked such that the mass transmission window is located within one of the troughs 14 of the mass peak then an ion signal with a significantly lower intensity would be transmitted. The present invention may therefore be used to reduce the impact on ion transmission level of placing the mass transmission window in slightly different places within the mass peak.

Although embodiments have been described in which the spread of axial energies of the ions is made relatively high, compared to the average axial energy, in order to smooth out the peaks and troughs that would otherwise appear in a mass peak, it is contemplated that other techniques may be performed to achieve this.

As described above, it has been recognised that when the axial energy spread of the ions is relatively low, compared to the average axial energy of the ions, then peaks and troughs may appear in a mass peak due to the transmission level of the ions varying as the mass transmission window of the mass filter is located at different mass to charge ratio positions within the mass peak. These peaks and troughs in the transmission occur at specific mass to charge ratio positions for the reasons discussed above.

More specifically, for a given ion species having a particular average axial kinetic energy, the peaks and troughs in the mass spectral data will appear at locations corresponding to specific q and a values in the Matthieu stability diagram, i.e. at specific combinations of amplitudes for the RF and DC voltages that are applied to the mass filter. For example, referring to FIG. 2, if the mass transmission window is located within one of the peaks 12 (e.g. at approximately m/z=74.2) then the intensity of the ion signal that is detected downstream of the mass filter will be relatively high, whereas if the mass transmission window is located within one of the troughs 14 (e.g. at approximately m/z=74.0) then the intensity of the ion signal that is detected downstream of the mass filter will be significantly lower, even though the peak 12 and trough 14 are located relatively close to the centre of the mass peak.

As described above, this is problematic when the mass filter is scanned, e.g. as the mass spectral data for a single ion species appears to have multiple different mass peaks. Also, this can be problematic when the mass transmission window of the mass filter is parked (i.e. maintained at a particular range of mass to charge ratios), since the ion transmission level through the mass filter will differ depending on which mass to charge ratio range at which the mass filter is parked. For example, this is problematic in Multiple Reaction Monitoring (MRM) experiments.

In order to overcome this problem, instead of maintaining the mass transmission window at a fixed range of mass to charge ratios when it is desired for the mass filter to transmit a particular ion species, e.g. in an MRM experiment, the mass transmission window may be scanned back and forth within a range of mass to charge ratios. This scanning is performed by varying the amplitudes of the RF and DC voltages applied to the mass filter, whilst keeping their ratio constant or varying their ratio. For example, the RF and DC voltages applied to the mass filter may be varied so as to change the q and a values in the Matthieu stability diagram, which varies the frequency with which ions that are transmitted by the mass filter oscillate radially. This varies the axial position of the nodes (and anti-nodes) in the envelope, for a given axial kinetic energy, and hence varies the ion transmission level.

For example, referring to FIG. 2, if a conventional MRM technique is used then the mass filter may be parked so that the mass transmission window only transmits ions having a mass to charge ratio of 74.0, which would provide a low level of ion transmission. In contrast, embodiments of this invention scan the mass transmission window back and forth across a pre-selected mass range that is expected to correspond to some, or all, of the mass to charge ratio values at which an ion species of interest would be transmitted by the mass filter. For instance, in the example shown in FIG. 2, the mass transmission window may be scanned back and forth between a mass to charge ratio of 73.8 and a mass to charge ratio 74.8. The ions that are transmitted by the mass filter, or ions derived therefrom, are detected downstream of the mass filter so as to obtain mass spectral data. Mass spectra data relating to the ions that are transmitted during the period that the mass transmission window is scanned back and forth may be summed so as to form a mass peak for the ion of interest, e.g. which may correlate the average intensity of the ions to a mass to charge ratio within the mass range.

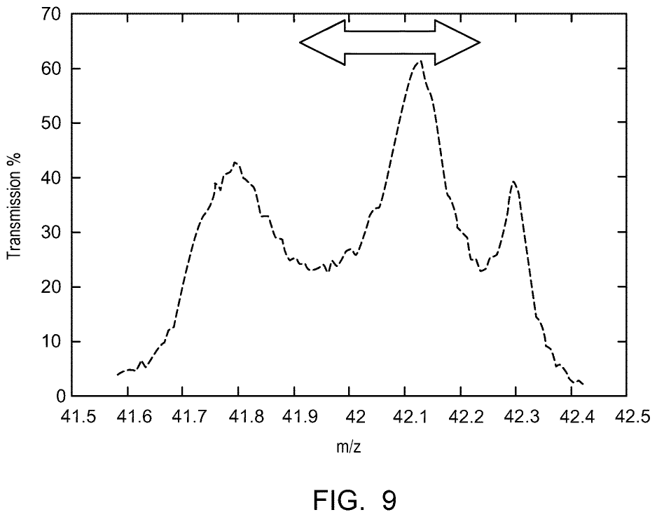

FIG. 9 shows another simulated mass peak exhibiting peaks 12 and troughs 14, in a similar manner to FIG. 2. The mass peak shown in FIG. 9 is for ions having a nominal mass to charge ratio of 42 and an average axial kinetic energy of 4eV. As can be seen, the mass peak has a width of approximately 0.7 Da. In this example, if the mass filter was parked so as to have its mass transmission window fixed so as to only transmit ions having a mass to charge ratio of 42.1, then the ion signal of the transmitted ions would be approximately twice what it would be if the mass transmission window was fixed so as to only transmit ions having a mass to charge ratio of 42.0. In order to overcome this problem, embodiments of the present invention modulate the position of the mass transmission window back and forth within the mass peak, e.g. between a mass to charge ratio of 41.9 and 42.2 as shown by the arrow. As described above, the mass spectra data relating to the ions that are transmitted during the period that the mass transmission window is scanned back and forth may be summed so as to form a mass peak for the ion of interest, e.g. which may correlate the average intensity of the ions to a mass to charge ratio within the mass range.

This technique is not only useful when the mass filter is parked at a particular mass to charge ratio, but it may also be used in embodiments where the mass transmission window of the mass filter is scanned, e.g. when the mass filter is scanned across a relatively large range of mass to charge ratios in order to transmit different ion species at different times. In such embodiments, rather than scanning the mass transmission window continuously and progressively in one direction (i.e. increasing or decreasing m/z), the mass transmission window is scanned back and forth within a relatively narrow range of mass to charge ratios that is centred on a central mass to charge ratio, and the value of the central mass to charge ratio is scanned over said wider range of mass to charge ratios.

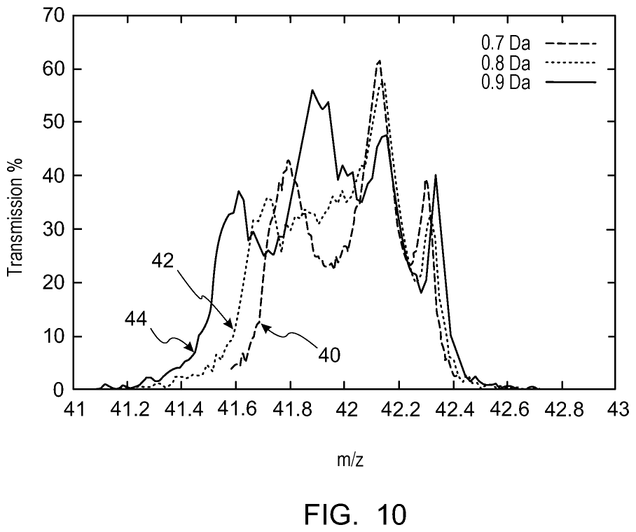

In addition to the above techniques, or alternatively, the resolution of the mass filter may be modulated in order to overcome the problems discussed herein. This is possible as varying the resolution of the mass filter will vary the mass to charge ratio positions at which the peaks 12 and troughs 14 are located, as will be described with reference to FIG. 10.

FIG. 10 shows three mass peaks, each of which has been obtained by scanning a mass filter across the range of mass to charge ratios shown, but wherein the resolution of the mass filter (i.e. the width of the mass transmission window) used in each scan is different. Mass peak 40 was obtained under the same conditions as that shown in FIG. 9 and has a mass peak width of 0.7 Da. Mass peak 42 is a mass peak obtained under the same conditions as mass peak 40, except that the width of the mass transmission window used to obtain the mass peak was increased, resulting in a mass peak having a width of 0.8 Da. Mass peak 44 is a mass peak obtained under the same conditions as mass peak 40, except that the width of the mass transmission window used to obtain the mass peak was increased further, resulting in a mass peak having a width of 0.9 Da. As can be seen from FIG. 10, varying the width of the mass transmission window (i.e. the resolution of the mass filter) causes the locations of the peaks 12 and troughs 14 within the mass peak to change.

As described above, if the mass filter is set to have its mass transmission window at any particular mass to charge ratio, such as in an MRM experiment, then the intensity of the ions that are transmitted may vary significantly depending on the mass to charge ratio that the window is set at. This is because the window may be located within a peak 12 or trough 14 of the mass peak. However, it has been recognised that the above problem may be mitigated by setting the mass transmission window so as to be centred at a particular mass to charge ratio and then varying the width of the mass transmission window with time. The mass spectra data relating to the ions that are transmitted whilst varying the width of the window may be summed so as to form a mass peak, e.g. which may correlate the average intensity of the ions to a mass to charge ratio within the window. This effectively averages the ions signals obtained with the different widths of mass transmission window, rending the measurement less susceptible to intensity variations that might otherwise occur depending on where the mass transmission window is located.

1. A method of mass spectrometry comprising:
supplying ions having an initial range of axial kinetic energies towards a mass filter; and
mass filtering the ions by applying different voltages to electrodes of the mass filter during different respective dwell times so as to provide different mass transmission windows during the different dwell times;
wherein the method comprises increasing the range of axial kinetic energies that the ions have, as they pass towards and/or through the mass filter, during at least one of the dwell times.

2. The method of claim 1, wherein the mass filter is a DC resolving quadrupole rod set mass filter.

3. The method of claim 1 or 2, wherein for each of said at least one of the dwell times, said step of increasing the range of axial kinetic energies causes ions of a given mass to charge ratio to exit the mass filter over the duration of that dwell time with a wider range of radial displacements from a central axis of the mass filter than the ions would have done if their axial kinetic energy had not been increased.

4. The method of any preceding claim, comprising providing a physical aperture, or an ion-optical device having an ion acceptance aperture defined by electric fields of the ion-optical device, downstream of the mass filter for receiving ions transmitted by the mass filter.

5. The method of any preceding claim, comprising detecting the ions transmitted during said different dwell times, or fragment or product ions thereof, downstream of the mass filter so as to generate mass spectral data, and summing the mass spectral data obtained over said different dwell times; optionally so as to form at least one mass peak corresponding to ions transmitted by the mass filter during said different dwell times, or for the fragment or product ions thereof.

6. The method of any preceding claim, wherein said step of increasing the range of axial kinetic energies comprises performing a plurality of cycles during each of said at least one of the dwell times, wherein each cycle comprises modulating the axial kinetic energy of the ions passing towards and/or through the mass filter between a minimum axial kinetic energy and a maximum axial kinetic energy.

7. The method of claim 6, comprising performing at least 5 cycles during each of said at least one of the dwell times.

8. The method of any preceding claim, wherein said step of increasing the range of axial kinetic energies that the ions have comprises:
providing the ions that reach the exit of the mass filter, over the course of one of the dwell times, with a first range of axial kinetic energies that are distributed about a first average axial kinetic energy; and
providing the ions that reach the exit of the mass filter, over the course of another of the dwell times, with a second range of axial kinetic energies that are distributed about a second average axial kinetic energy;
wherein the second range of axial kinetic energies is wider than the first range of axial kinetic energies, and the second average axial kinetic energy is higher than the first average axial kinetic energy.

9. The method of any preceding claim, wherein said step of increasing the range of axial kinetic energies comprises providing a DC potential difference along an axial region of the mass filter, or along an axial region upstream of the mass filter, and varying the DC potential difference during each of said at least one of the dwell times such that ions entering said axial region at different times are imparted with different axial kinetic energies.

10. The method of any preceding claim, comprising increasing the range of axial kinetic energies of the ions, as they pass towards and/or through the mass filter, so that the ions have a first range of axial kinetic energies during a first of said dwell times, during which the mass filter has a mass transmission window set to transmit ions in a first range of mass to charge ratios;
wherein the method further comprises:
(i) increasing the range of axial kinetic energies of the ions, as they pass towards and/or through the mass filter, so that the ions have a second range of axial kinetic energies that is narrower than said first range of axial kinetic energies during a second of said dwell times, during which the mass filter has a mass transmission window set to transmit ions in a second range of mass to charge ratios that is higher than said first range of mass to charge ratios; and/or
(ii) not increasing the range of axial kinetic energies of the ions, as they pass towards and/or through the mass filter, during a dwell time at which the mass filter has a mass transmission window set to transmit ions in a range of mass to charge ratios that is higher than the first and/or second range of mass to charge ratios.

11. The method of any preceding claim, comprising providing the ions with a first average axial kinetic energy through the mass filter during a dwell time at which the mass filter has a mass transmission window set to transmit ions in one range of mass to charge ratios; and
providing the ions with a second average axial kinetic energy through the mass filter, that is lower than the first average axial kinetic energy, during a dwell time at which the mass filter has a mass transmission window set to transmit ions in a range of mass to charge ratios that is higher than said one range of mass to charge ratios.

12. A mass spectrometer comprising:
a mass filter having electrodes;
at least one voltage supply for applying voltages to the electrodes; and
control circuitry configured to control the mass spectrometer to:
supply ions having an initial range of axial kinetic energies towards the mass filter;
control the at least one voltage supply to apply different voltages to electrodes of the mass filter during different respective dwell times so as to provide the mass filter with different mass transmission windows during the different dwell times; and
increase the range of axial kinetic energies that the ions have, as they pass towards and/or through the mass filter, during at least one of the dwell times.

13. The mass spectrometer of claim 12, comprising electrodes and one or more voltage supplies configured to provide a DC potential difference along an axial region of the mass filter, or along an axial region upstream of the mass filter, wherein the control circuitry is configured to control the mass spectrometer to increase the range of axial kinetic energies by controlling the one or more voltage supplies so as to vary the DC potential difference during each of said at least one of the dwell times such that ions entering said axial region at different times are imparted with different axial kinetic energies.

14. A method of mass spectrometry comprising:
supplying ions towards a mass filter having a mass transmission window; and
increasing the range of axial kinetic energies that the ions have as they pass towards and/or through the mass filter.

15. A mass spectrometer comprising:
a mass filter having electrodes;
at least one voltage supply for applying voltages to the electrodes so as to provide the mass filter with a mass transmission window; and
control circuitry configured to control the mass spectrometer to:
supply ions towards the mass filter; and
increase the range of axial kinetic energies that the ions have as they pass towards and/or through the mass filter.

16. A method of mass spectrometry comprising:
(i) mass filtering ions using a mass filter having a mass transmission window;
(ii) repeatedly scanning the mass transmission window across a range of mass to charge ratios that has a width of less than 1 Da.

17. The method of claim 16, wherein the step of repeatedly scanning is performed during a single experimental run, such as over a period during which ions are substantially continually supplied to the mass filter and/or during which analyte is continually supplied to a mass spectrometer that comprises the mass filter.

18. The method of claim 16 or 17, wherein the step of repeatedly scanning is performed over a time period and ions transmitted by the mass filter during said time period, or ions derived therefrom, are detected so as to obtain mass spectral data; and wherein the mass spectral data is summed or averaged.

19. The method of claim 18, comprising associating the summed or averaged mass spectral data with a mass to charge ratio within said range of mass to charge ratios.

20. The method of any one of claims 16-19, wherein the step of repeatedly scanning comprises scanning the mass transmission window back and forth in opposing directions across said range of mass to charge ratios.

21. The method of any one of claims 16-20, comprising selecting a target mass to charge ratio that is desired to be transmitted by the mass filter and then performing said steps of mass filtering and repeatedly scanning, wherein said range of mass to charge ratios that the mass transmission window is repeatedly scanned across includes said target mass to charge ratio.

22. A method of mass spectrometry comprising:
(i) mass filtering ions using a mass filter having a mass transmission window;
(ii) varying the width of the mass transmission window whilst the centre of the mass transmission window is maintained at a constant mass to charge ratio value.

23. The method of claim 22, wherein step (ii) is performed over a time period and ions transmitted by the mass filter during said time period, or ions derived therefrom, are detected so as to obtain mass spectral data; and wherein the mass spectral data is summed or averaged.

24. The method of claim 22 or 23, comprising selecting a target mass to charge ratio that is desired to be transmitted by the mass filter and then performing steps (i) and (ii), wherein said target mass to charge ratio remains within the window during step (ii).

25. The method of claim 22, 23 or 24, wherein the method forms part of a multiple reaction monitoring experiment for analysing a target ion of interest having said target mass to charge ratio, and wherein said steps (i) and (ii) are performed in order to cause the mass filter to transmit the target ion of interest.
